(19) United States
(12) Patent Application Publication
(10) Pub. No.: US 2017/0211311 A1
(43) Pub. Date: Jul. 27, 2017

(54) ROTATABLE AND HUNG SAFETY WINDOW ASSEMBLY

(71) Applicant: Donghyun JANG, Gwangmyeong-si (KR)

(72) Inventor: Donghyun JANG, Gwangmyeong-si (KR)

(21) Appl. No.: 15/298,354

(22) Filed: Oct. 20, 2016

(30) Foreign Application Priority Data
Jan. 22, 2016 (KR) 10-2016-0008198

(51) Int. Cl. E06B 3/50; E05D 15/48; E05D 15/20; E05C 19/00; E05C 7/04

(52) U.S. Cl. CPC E06B 3/5063; E05C 19/003; E05C 7/04; E05D 15/20; E05D 15/48; E05D 2015/487

(57) ABSTRACT

There is provided a rotatable and hung safety window assembly comprising: a housing having opposite holes defined in opposite inner side walls thereof respectively; a guide chassis disposed in an upper space in the housing, wherein the guide chassis has opposite guide grooved lines defined in opposite inner side walls thereof respectively; a rotatable chassis disposed in a lower space in the housing, wherein the rotatable chassis has opposite hinge protrusions formed on opposite outer side walls thereof to correspond to the opposite holes respectively, wherein the hinge protrusions are hingedly received in the holes respectively; an upper window having opposite guide protrusions formed on opposite outer side walls thereof, wherein the guide protrusions are slidably received in the first guide grooved lines; and a lower window fitted into the rotatable chassis.

### CROSS-REFERENCE TO RELATED APPLICATION

This application claims the benefit of Korea patent application No. 10-2016-0008198, filed on Jan. 22, 2016, the entire content of which is incorporated herein by reference for all purposes as if fully set forth herein.

### BACKGROUND

Field of the Present Disclosure

The present disclosure relates to a rotatable and hung safety window assembly, and, more particularly, to a rotatable and hung safety window assembly to act as both of a hung type window and a hinge type window.

Discussion of Related Art

Korean Utility Model number 20-0228474 discloses “a double window assembly with improved safety”, wherein an inner window is configured to act as a sidling window and an outer window is configured to act as a hinge type window. However, such a type of the double window assembly may lead to a high production cost due the fact that the inner and outer windows are separately provided. Further, such a type of the double window assembly may require a large installation space.

Further, Korean Patent application publication No. 10-2015-0038763 discloses a double hung window having a double glazing structure to apply a double glazing structure to a double hung window in the indoor and outdoor sides of a window frame, thereby preventing dew condensation and having improved heat insulation performance. To achieve this, the double hung window having a double glazing structure comprises: a window frame; a first double hung window installed in the indoor side of the window frame to be opened or closed; and a second double hung window installed in the outdoor side of the window frame at a space from the first double hung window to be opened or closed. According to the present invention, the double hung window having a double glazing structure prevents dew condensation and has improved heat insulation performance by applying a double glazing structure to the indoor and outdoor sides of a window frame. In addition to this, the double hung window having a double glazing structure can control the flow of air intake through a space between the first and second double hung windows in accordance with the solar radiation change and outdoor air conditions as the first and second double hung windows are separated from each other at a predetermined space to form a double glazing structure. Such a type of the double window assembly may have the shortcoming that the window space is not completely open.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

Thus, the present disclosure is to provide a rotatable and hung safety window assembly to act as both of a hung type window and a hinge type window.

In one aspect of the present disclosure, there is provided a rotatable and hung safety window assembly comprising: a housing having an inner space defined therein, wherein the housing has opposite holes defined in opposite inner side walls thereof respectively; a guide chassis disposed in an upper space of the inner space, wherein the guide chassis has opposite first guide grooved lines defined in opposite inner side walls thereof respectively, wherein each first guide line extends vertically; a rotatable chassis disposed in a lower space of the inner space, wherein the rotatable chassis has opposite hinge protrusions formed on opposite outer side walls thereof to correspond to the opposite holes respectively, wherein the hinge protrusions are hingedly received in the holes respectively; an upper window having opposite guide protrusions formed on opposite outer side walls thereof, wherein the guide protrusions are slidably received in the first guide grooved lines; and a lower window fitted into the rotatable chassis.

In one implementation, the rotatable chassis has second guide grooved lines defined in opposite inner side walls thereof respectively, wherein each second guide line extends vertically and contacts each first guide line.

In one implementation, the rotatable chassis has opposite stoppers formed on opposite inner side walls thereof respectively at bottom ends of the second guide grooved lines.

In one implementation, the assembly further comprises opposite rotation links at opposite sides of the rotatable chassis, each link having one end coupled to the rotatable chassis and the other end coupled to the housing, wherein each rotation link is configured to allow the rotatable chassis to rotate on the hinge protrusions.

In one implementation, the assembly further comprises opposite stoppers at opposite sides of the housing, each stopper extending from the housing outwardly in a predetermined angle, each stopper stopping the rotation of the rotatable chassis.

In one implementation, the assembly further comprises a foldable screener having one end coupled to the housing and the other end coupled to the rotatable chassis, wherein when the rotatable chassis rotates, the foldable screen varies in a length thereof.

In one implementation, the assembly further comprises a locker mechanism, wherein the locker mechanism includes: a locker bar, and at least two locker links, each link having one end hingedly coupled to the lower window and the other end hingedly coupled to the locker bar.

In one implementation, the locker bar has at least two horizontal elongate slots.

In one implementation, the lower window has a vertical length larger than a vertical length of the upper window.

In one implementation, the assembly further comprises a cover formed in a stepped shape, wherein the cover is coupled to top faces of the upper window and the lower window when the upper window and the lower window are arranged side by side horizontally, wherein the cover is coupled to the rotatable chassis via a hinge.

In one implementation, the rotatable chassis has a cover accommodation hole defined therein, wherein the cover is configured to receive in the cover accommodation hole.

In accordance with the present disclosure, the user' hand may be prevented from being inserted into the gap between the upper and lower windows and/or between the housing and the rotatable chassis. Thus, the user' hand may be not damaged.

Further, since the single window assembly act as both the hinge type window and the hung type window, the assembly production cost may be lower and the installation space thereof may require a smaller area.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is an exploded perspective view of a rotatable and hung safety window assembly in accordance with one embodiment of the present disclosure.

FIG. 2 is a perspective view illustrating an operation of a rotatable and hung safety window assembly in accordance with one embodiment of the present disclosure.

FIG. 3 is a perspective view of a locking mechanism of the rotatable and hung safety window assembly in accordance with one embodiment of the present disclosure.

FIG. 4 is a perspective view of an operation of a locking mechanism of the rotatable and hung safety window assembly in accordance with one embodiment of the present disclosure.

FIG. 5 is a perspective view of a cover of the rotatable and hung safety window assembly in accordance with one embodiment of the present disclosure.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

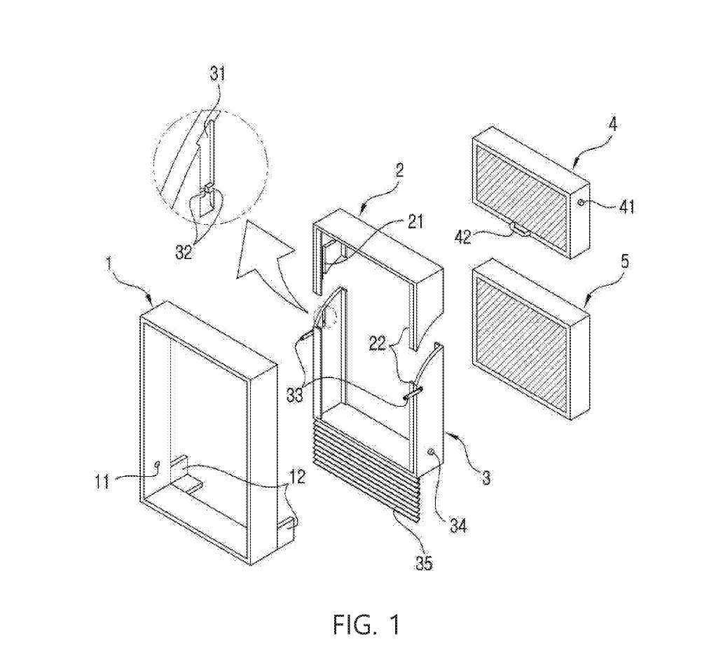

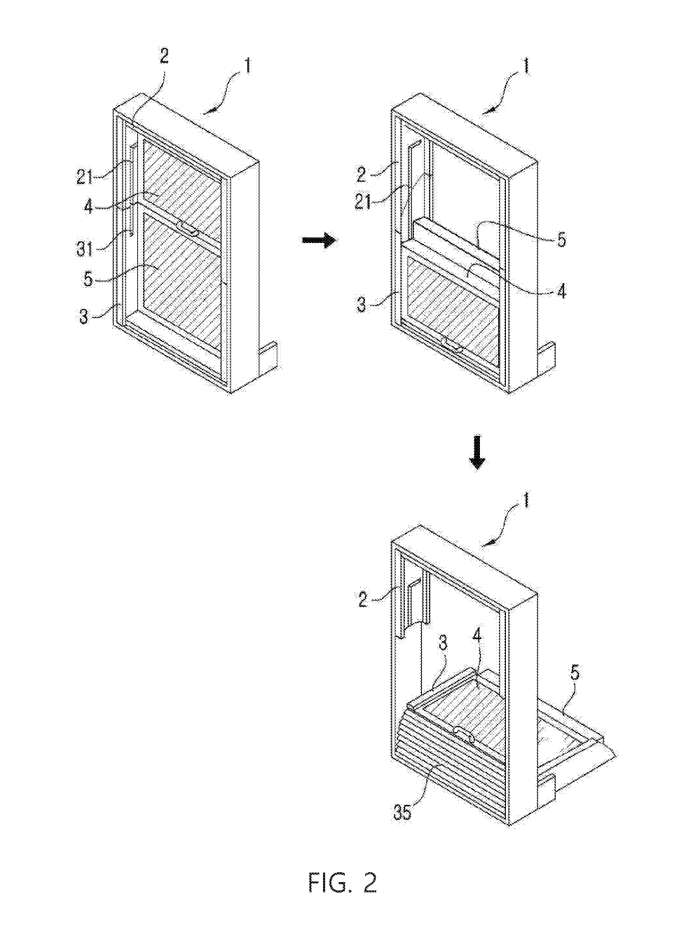

FIG. 1 is an exploded perspective view of a rotatable and hung safety window assembly in accordance with one embodiment of the present disclosure. FIG. 2 is a perspective view illustrating an operation of a rotatable and hung safety window assembly in accordance with one embodiment of the present disclosure.

The rotatable and hung safety window assembly in accordance with one embodiment of the present disclosure may include an upper window 4, a lower window 5, a guide chassis 2, a rotatable chassis 3, and a housing 1.

In the housing 1, the guide chassis 2 and rotatable chassis 3 are disposed. The guide chassis 2 is positioned over the rotatable chassis 3. Further, the guide chassis 2 may be coupled to the upper window 4. The rotatable chassis 3 may be coupled to the lower window 5. The guide chassis 2 and rotatable chassis 3 may be made of the same material as that of a conventional window frame to support the windows. Thus, the housing 1, guide chassis 2, and rotatable chassis 3 may be made of, for example, aluminum, a synthetic resin, etc.

The housing 1 may refer to a rectangular frame having an inner rectangular space defined therein. The housing 1 may have first opposite holes 11 formed at an inner lower portion of the housing in both opposite inner side walls of the housing respectively. The extension line between the first opposite holes 11 may act as the rotation axis of the rotatable chassis 3. For this reason, the first opposite holes 11 may be preferably positioned at the lowest level of the inner side walls of the housing. The guide chassis 2 and rotatable chassis 3 may be received in and fitted with the inner space in the housing 1.

The guide chassis 2 may be coupled to the upper portion of the housing 1. The rotatable chassis 3 may be coupled to the lower portion of the housing 1. A length of each of the guide chassis 2 and rotatable chassis 3 may correspond to ½ of a total vertical length of the inner space of the housing 1. However, the present disclosure may not be limited thereto. For example, in order to improve the safety, the rotatable chassis 3 may have a longer vertical length that that of the guide chassis 2. This configuration results in a step between the upper window 4 and lower window 5 when the upper window 4 and lower window 5 overlaps each other. This step may allow a fixing of the upper window 4 and lower window 5 using a locker bar 52 or cover 36 as described later when the rotatable chassis 3 has rotated to the horizontal orientation.

Each of the guide chassis 2 and rotatable chassis 3 may have one open side. The guide chassis 2 and rotatable chassis 3 may have a tilted or rounded tilted ends at the contacting portions thereof. This may facilitate the rotation of the rotatable chassis 3. The guide chassis 2 may be fixed to the housing 1 at the upper portion thereof. The guide chassis 2 may have guide grooved lines 21 vertically defined at opposite inner side walls thereof respectively. The rotatable chassis 3 may have hinge protrusions 34 formed on opposite outer side walls thereof respectively so as to be received in the first opposite holes 11 of the housing 1 respectively.

In this way, the guide chassis 2 may be fixed to the housing 1. The rotatable chassis 3 may rotate via the hinge protrusion 34 from the housing 1.

The guide chassis 2 may have the guide grooved lines 21. The guide grooved lines 21 may respectively receive guide protrusions 41 formed on opposite outer side walls of the upper window 4 respectively. The upper window 4 may be fitted into the guide chassis 2. The upper window 4 may be made of a transparent material such as a glass, acryl, etc. Thus, a sliding of the guide protrusions 41 in and along the guide grooved lines 21 may guide the upper window 4 along the guide lines 21.

The rotatable chassis 3 may have the hinge protrusions 34 to be received in the first opposite holes 11 defined in the housing 1 respectively. The rotatable chassis 3 may have an inner space defined therein to receive the lower window 5. The lower window 5 may not have the guide protrusions. The lower window 5 may be fixed to the rotatable chassis 3.

The housing 1 may have the inner accommodation space to receive the guide chassis 2, and rotatable chassis 3, which receives the upper window 4 and lower window 5 respectively. The guide chassis 2 may be coupled to the upper window 4, while the rotatable chassis 3 may be coupled to the lower window 5. In an upper portion of the inner space of the housing 1, the guide chassis 2 may be disposed, while, in a lower portion of the inner space of the housing 1, the rotatable chassis 3 may be disposed. The bottom of the upper window 4 may contact the top of the lower window 5 to realize the closing mode of the present rotatable and hung safety window assembly. In order to pull the upper window 4 toward the lower window 5, a handle 42 may be formed on the upper window 4 at the bottom end thereof. Thus, the user may pull the handle 42 and lower down the upper window 4 along the guide grooved lines 21 toward the lower window. In order to guide the upper window 4 to overlap the lower window 5 side by side horizontally, a horizontal grooved guide line may be formed in each of the opposite inner side wall of the guide chassis 2. Each horizontal grooved guide line may be coupled to each vertical grooved guide line in a right angle. Each horizontal grooved guide line may have a length larger than or equal to the thickness of the lower window 5. In this way, the user may pull the upper window 4 along the horizontal grooved guide lines and then lower down the upper window 4 along the vertical grooved guide lines, such that the upper window 4 may be arranged horizontally side by side with the lower window 5. In this way, both the lower window 5 and upper window 4 may be accommodated in the rotatable chassis 3. For the sake of a convenience, an esthetic aspect, and an easy operation, when the upper window 4 may be arranged horizontally side by side with the lower window 5, the lower window 5 may act as an outer window and the upper window 4 as an inner window.

In order to reach the state that the upper window 4 is lowered down to contact the bottom of the rotatable chassis 3 at the bottom end of the upper window 4, further guide grooved lines 31 may be vertically formed in opposite inner side walls of the rotatable chassis 3 at a predetermined length respectively to be coupled to the vertical guide grooved lines 21 defined in the guide chassis 2 respectively. In order to stop the movement of the upper window 4, stopper protrusions 32 may be formed on the opposite inner side walls of the rotatable chassis 3. In this way, the downward movement of the upper window 4 along the further guide grooved lines 31 may stop at the stopper protrusions 32 when the guide protrusions 41 contact the stopper protrusions 32 respectively.

Optionally, each of the guide chassis 2 and rotatable chassis 3 may have a chassis guard 22 partially extending in a parallel direction to a window plane of the upper window 4 and lower window 5. Thus, the chassis guard 22 may prevent the upper window 4 and lower window 5 from being removed away from the guide chassis 2 and rotatable chassis 3 due to the external force such as a heavy wind, etc.

The rotation of the rotatable chassis 3 via the hinge protrusion 34 may be limited in a rotation range in following manners. First, the hinge protrusion 34 may have a semi-circular shape and the first opposite hole 11 may have an arc shape with a length larger than a length of the semi-circular shape of the hinge protrusion 34. In this way, the rotation of the hinge protrusion 34 in the first opposite hole 11 may be limited in a rotation range. However, this approach may have shortcomings that the hinge protrusion 34 and first opposite holes 11 should have sufficient sizes and durability to withstand the repeated rotations thereof. Second, a stopper 12 may be formed to extend, for example, in a horizontal direction. The stopper 12 may extend from the housing 1 at the bottom thereof outwards. However, the present disclosure may not be limited thereto. The stopper 12 may be formed to extend in a predetermined angle to control the rotation range of the rotatable chassis 3.

Further, each rotatable link 33 may be hingedly coupled to the rotatable chassis 3 and housing 1 at each side of the rotatable chassis 3 and housing 1. Thus, when the stopper 12 is damaged not to control the rotation range of the rotatable chassis 3, the rotatable links 33 may maintain the rotation range of the rotatable chassis 3.

In addition, a screener 35 may be disposed to prevent the user' hand from being inserted into between the rotatable chassis 3 and housing 1. As the rotatable chassis 3 rotates, the screener 35 may be configured to vary in a size thereof. Thus, the screener 35 may be foldable in multiple times. This may have an advantage that the screener 35 may be kept in a small size when the rotatable chassis 3 is upright. To this end, the screener 35 is coupled, at one end thereof, to the housing 1 at a bottom thereof, and is coupled, at the other end thereof, to the rotatable chassis 3 at a bottom thereof. When the rotatable chassis 3 rotates, the screener 35 may be spread out based on the rotation angle of the rotatable chassis 3. In this way, the screener 35 may prevent the user' hand from being inserted into between the rotatable chassis 3 and housing 1.

Moreover, each of the rotatable chassis 3, stopper 12, upper window 4, lower window 5, and/or chassis guard 22 may have corners with an elastic coating made of an elastic material such as silicon. The elastic coating may act as the protection cover to prevent the user from being damaged from the corners.

An operation of the rotatable and hung safety window assembly in accordance with one embodiment of the present disclosure will be as follows: initially, in a closing mode, the upper window 4 and lower window 5 may be vertically arranged side by side. Then, the user may pull the handle 42 of the upper window 4 inwardly and down along the guide grooved lines 21 of the guide chassis 2. The upper window 4 may be accommodated in the rotatable chassis 3 in the housing 1. Thus, the lower window 5 and upper window 4 may be arranged side by side horizontally. In other words, they may overlap horizontally. The upper window 5 may be secured via the stopper protrusions 32 at bottom ends of the further guide grooved lines 31. In this state, the user may push the upper window 4 outwardly to rotate the upper window 4 and lower window 5, and rotatable chassis 3 collectively toward the stopper 12. At the same time, the screener 35 may be spread out based on the rotation angle of the rotatable chassis 3 to prevent the user' hand from being inserted into between the rotatable chassis 3 and housing 1. In this way, the rotatable and hung safety window assembly in accordance with one embodiment of the present disclosure may act as both the hung window and hinged window.

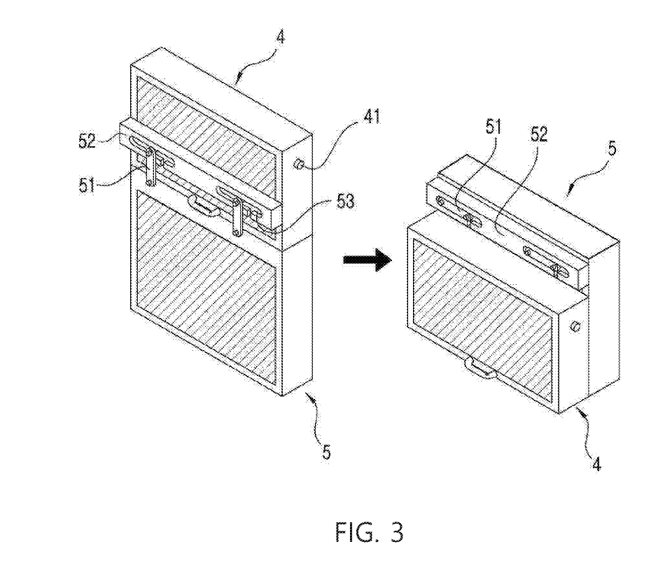

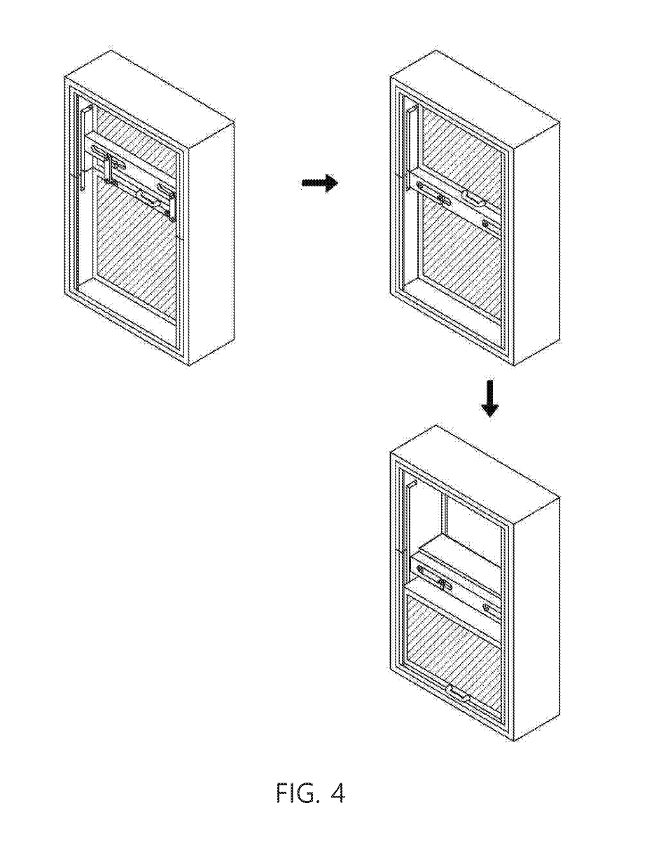

FIG. 3 is a perspective view of a locking mechanism of the rotatable and hung safety window assembly in accordance with one embodiment of the present disclosure. FIG. 4 is a perspective view of an operation of a locking mechanism of the rotatable and hung safety window assembly in accordance with one embodiment of the present disclosure.

The rotatable and hung safety window assembly in accordance with one embodiment of the present disclosure may have a locking mechanism to improve the safety thereof. The locking mechanism may have a locker bar 52 on a lower end of the upper window 4 on an inner face thereof, and multiple (in this example, two) locker links 51, each link having a lower end coupled to the lower window 5 and an upper end coupled to the locker bar 52.

The locker bar 52 may be made of a material capable of absorbing an external shock such as rubber, silicon, sponge, etc. The locker bar 52 may have substantially the same length as the horizontal width of the upper window 4. The locker bar 52 may have a thickness smaller than or equal to the thickness of the upper window 4 or lower window 5.

The locker link 51 may be hingedly moveable. To this end, the locker link 51 may have one end hingedly coupled to the lower window 5 and the other end hingedly coupled to the locker bar 52. The locker link 51 may operate in a vehicle-wiper manner. Although not shown, each locker link 51 may be outwardly tilted from the lower window 5 to the locker bar 52. This tiled configuration may allow the locker bar 52 to more reliably pressure the upper window 4 to improve a safety of the present window.

The locker bar 52 may have multiple elongate slots 53 at the locations where the locker links 51 are hingedly coupled to the locker bar 52. Thus, each locker link 51 may be moveable along each elongate slot 53. The locker bar 52 may be moveable via the movement of the locker link 51. The elongate slot 53 may act as a movement channel of the locker link 51. Further, the locker bar 52 may move in a vehicle-wiper manner via the hingedly movement of the locker link 51.

In operation, in a closing mode, when the upper window 4 and lower window 5 may be arranged side by side vertically, the locker bar 52 may be moved so as to block a boundary between the upper window 4 and lower window 5. Thus, the user' hand may be prevented from being inserted into between the lower window 5 and upper window 4. At the same time, the locker bar 52 may prevent the upper window 4 from moving inwardly and downwardly along the guide lines to open the present window.

In an open mode, the locker bar 52 may be moved to unblock the upper window 4, then, the upper window 4 may be pulled down to overlap the lower window 5. Thus, the overlap between the upper window and lower window may define the step portion because the upper window has a smaller vertical length than that of the lower window. The locker bar 52 may be moved to be located in the step portion. In this state, the locker link 51 may be oriented horizontally. Thus, the space between the upper window 4 and lower window 5 may be blocked by the locker bar 52. In this way, the user' hand may be prevented from being inserted into between the lower window 5 and upper window 4. When the upper window has the same vertical length as that of the lower window, the locker bar 52 may be located at a top of the lower window 5 and upper window 4 to prevent the user' hand from being inserted into between the lower window 5 and upper window 4. Further, the locker bar 52 may prevent the upper window 4 from being removed away from the rotatable chassis 3.

In order to allow the movement of the upper window 4 when the lower window 5, locker bar 52, and upper window 4 are collectively accommodated in the rotatable chassis 3, there may be a clearance or gap between the upper window 4 and lower window 5. In order to improve the movement of the upper window 4, the locker bar 52 may be made of an elastic material and/or may have rounded corners. When the locker bar 52 may be made of an elastic material, the locker bar 52 may be shrunk during the downward movement of the upper window 4, while, the locker bar 52 may be restored in a volume when the locker bar 52 may be located in a boundary between the upper window 4 and lower window 5, thereby to block the gap or clearance between the upper and lower windows. When the locker bar 52 has the rounded corners, the movement of the upper window 4 may be more facilitated.

In addition, the locker link 51 may be coupled to the lower window 5 via a height-adjustable shaft (not shown), In this way, the level of the locker link 51 may be adjusted freely. The locker bar 52 may have more flexible movements. Thus, the locker bar 52 may be reliably positioned to block the gap between the upper window 4 and lower window 5. Further, the locker bar 52 may have a shaft channel passing through to the slot 53 to allow the shaft to move through the shaft channel to be received into the slot 53.

The operation of the rotatable and hung safety window assembly in accordance with one embodiment of the present disclosure may be as follows in more details: initially, the upper window 4 and lower window 5 may be arranged side by side vertically, which may be a closing mode. In this connection, the locker bar 52 hingedly coupled to the lower window 5 via the locker link 51 may be located at the highest position via an upright orientation of the locker link 51, such that the locker bar 52 may push outwards the upper window 4 and lock the movement of the upper window 4. In order to move the upper window 4 down, the locker bar 52 may be hingedly lowered down toward the lower window. In this connection, the locker link 51 may move along the elongate slot 53 defined in the locker bar 52, and the shaft (not shown) coupled to the locker link 51 may be received in the elongate slot 53. Thus, the locker bar 52 may be moved to the lower window 5. Subsequently, the user may pull the handle 42 on the upper window 4 to move inwardly and down the upper window 4. Thus, the upper window may be guided along the guide grooved lines 21 defined in the guide chassis 2. In this connection, since the locker bar 52 is made of the deformable material such as an elastic material, the movement of the upper window 4 may not be restricted. The upper window 4 may be located in the rotatable chassis 4 in an inner portion thereof. In this way, the lower window 5 and upper window 4 may be accommodated in the guide chassis 2 to overlap horizontally with each other. The upper window 4 may be secured by the stopper protrusion 32 formed at the bottom end of the further guide grooved line 31. In this state, the locker bar 52 may be positioned to a boundary between the lower window 5 and upper window 4 to bock the gap therebetween. Thus, the user' hand may be prevented from being inserted into between the lower window 5 and upper window 4.

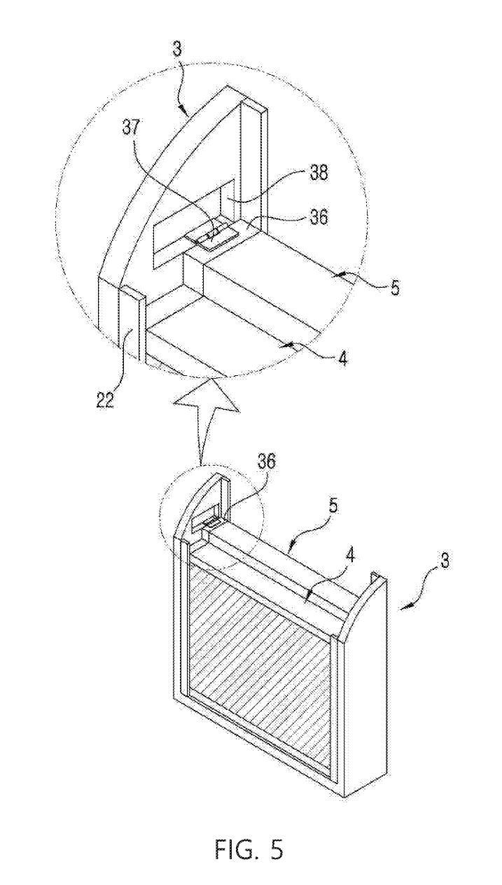

FIG. 5 is a perspective view of a cover of the rotatable and hung safety window assembly in accordance with one embodiment of the present disclosure.

The rotatable and hung safety window assembly in accordance with one embodiment of the present disclosure may have the cover 36 to prevent the upper window 4 from being separated from the rotatable chassis during the rotation of the rotatable chassis. The cover 36 may be coupled to the rotatable chassis 3 at each side thereof via each hinge. The cover 36 may have a liner shape or stepped shape. The stepped shape may correspond to the step portion defined by the upper window 4 and lower window 5 overlapping each other horizontally in case that the upper window and lower window have different vertical lengths as described above. Further, a fixing guard may be formed in the stepped shape at each side of the rotatable chassis to function like the chassis guard 22. Thus, the cover 36 may be hingedly rotated to be coupled to the top portions of the upper window 4 and lower window. In this state, the rotatable chassis 3 may rotate. Due to the cover 36, during the rotation of the rotatable chassis 3, the upper window 4 may be prevented from being separated from the rotatable chassis 3.

When the cover 36 is coupled to the rotatable chassis 3 via the hinge, it has a disadvantage that the rotatable chassis 3 should extend by the length of the cover 36. In order to remedy the disadvantage, a cover accommodation hole 38 may be formed in the rotatable chassis 3 to have a corresponding size and position to the cover 36. In this connection, the hinge may be disposed adjacent to the cover accommodation hole 38. Normally, the cover 36 may be received in the cover accommodation hole 38. When the upper window 4 is moved into the rotatable chassis 3, the cover 36 may be withdrawn from the cover accommodation hole 38 and may be coupled to the upper window 4 and lower window 5 on the top faces thereof. This may remove the need for changing the existing chassis size. Further, this may allow utilization of non-used portions in the existing chassis. This may allow the existing chassis to be adapted for the present rotatable and hung safety window assembly.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A rotatable and hung safety window assembly comprising:
a housing having an inner space defined therein, wherein the housing has opposite holes defined in opposite inner side walls thereof respectively;
a guide chassis disposed in an upper space of the inner space, wherein the guide chassis has opposite first guide grooved lines defined in opposite inner side walls thereof respectively, wherein each first guide line extends vertically;
a rotatable chassis disposed in a lower space of the inner space, wherein the rotatable chassis has opposite hinge protrusions formed on opposite outer side walls thereof to correspond to the opposite holes respectively, wherein the hinge protrusions are hingedly received in the holes respectively;
an upper window having opposite guide protrusions formed on opposite outer side walls thereof, wherein the guide protrusions are slidably received in the first guide grooved lines; and
a lower window fitted into the rotatable chassis.

2. The assembly of claim 1, wherein the rotatable chassis has second guide grooved lines defined in opposite inner side walls thereof respectively, wherein each second guide line extends vertically and contacts each first guide line.

3. The assembly of claim 2, wherein the rotatable chassis has opposite stoppers formed on opposite inner side walls thereof respectively at bottom ends of the second guide grooved lines.

4. The assembly of claim 1, further comprising opposite rotation links at opposite sides of the rotatable chassis, each link having one end coupled to the rotatable chassis and the other end coupled to the housing, wherein each rotation link is configured to allow the rotatable chassis to rotate on the hinge protrusions.

5. The assembly of claim 1, further comprising opposite stoppers at opposite sides of the housing, each stopper extending from the housing outwardly in a predetermined angle, each stopper stopping the rotation of the rotatable chassis.

6. The assembly of claim 1, further comprising a foldable screener having one end coupled to the housing and the other end coupled to the rotatable chassis, wherein when the rotatable chassis rotates, the foldable screen varies in a length thereof.

7. The assembly of claim 1, further comprising a locker mechanism, wherein the locker mechanism includes: a locker bar, and at least two locker links, each link having one end hingedly coupled to the lower window and the other end hingedly coupled to the locker bar.

8. The assembly of claim 7, wherein the locker bar has at least two horizontal elongate slots.

9. The assembly of claim 1, wherein the lower window has a vertical length larger than a vertical length of the upper window.

10. The assembly of claim 9, further comprising a cover formed in a stepped shape, wherein the cover is coupled to top faces of the upper window and the lower window when the upper window and the lower window are arranged side by side horizontally, wherein the cover is coupled to the rotatable chassis via a hinge.

11. The assembly of claim 10, wherein the rotatable chassis has a cover accommodation hole defined therein, wherein the cover is configured to receive in the cover accommodation hole.
